(19) United States
(12) Patent Application Publication
(10) Pub. No.: US 2026/0170820 A1
(43) Pub. Date: Jun. 18, 2026

(54) METHOD AND APPARATUS WITH NEURAL NETWORK DATA PROCESSING

(71) Applicant: SAMSUNG ELECTRONICS CO., LTD., Suwon-si (KR)

(72) Inventors: Changin CHOI, Suwon-si (KR); Changyong SON, Anyang-si (KR); Seohyung LEE, Seoul (KR); Sangil JUNG, Yongin-si (KR)

(73) Assignee: SAMSUNG ELECTRONICS CO., LTD., Suwon-si (KR)

(21) Appl. No.: 19/418,035

(22) Filed: Dec. 12, 2025

Related U.S. Application Data
(63) Continuation of application No. 17/111,870, filed on Dec. 4, 2020, now abandoned.

(30) Foreign Application Priority Data
Jun. 18, 2020 (KR) 10-2020-0074234

(51) Int. Cl. G06V 10/82; G06F 18/211; G06N 3/063; G06N 3/08

(52) U.S. Cl. CPC G06V 10/82; G06F 18/211; G06N 3/063; G06N 3/08

(57) ABSTRACT

A processor-implemented neural network data processing method includes: determining a total number of either one of a first feature value and values less than or equal to the first feature value, in feature data output from a layer of a neural network; determining a quantization parameter based on the determined number; quantizing the feature data based on the determined quantization parameter; and inputting the quantized feature data to a another layer of the neural network connected to the layer.

### CROSS-REFERENCE TO RELATED APPLICATIONS

This application is a Continuation of U.S. application Ser. No. 17/111,870, filed Dec. 4, 2020, which claims the benefit under 35 USC § 119(a) of Korean Patent Application No. 10-2020-0074234 filed on Jun. 18, 2020, in the Korean Intellectual Property Office, the entire disclosures of which are incorporated herein by reference for all purposes.

### BACKGROUND

### 1. Field

The following description relates to a method and apparatus with neural network data processing.

### 2. Description of Related Art

The technological automation of processes such as user verification or authentication based on, for example, a face or fingerprint of a user, through a recognition model such as a classifier and the like may be implemented through a processor-implemented neural network model, as specialized computational architectures, which, after substantial training, may provide computationally intuitive mappings between input patterns and output patterns. The trained capability of generating such mappings may be referred to as a learning capability of the neural network. Further, because of the specialized training, such specially trained neural network may thereby have a generalization capability of generating a relatively accurate output with respect to an input pattern that the neural network may not have been trained for, for example.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor-implemented neural network data processing method includes: determining a total number of either one of a first feature value and values less than or equal to the first feature value, in feature data output from a layer of a neural network; determining a quantization parameter based on the determined number; quantizing the feature data based on the determined quantization parameter; and inputting the quantized feature data to a another layer of the neural network connected to the layer.

The determining of the quantization parameter may include: selecting a target feature distribution corresponding to the feature data from among candidate feature distributions based on the determined number; and determining the quantization parameter based on the selected target feature distribution.

The selecting of the target feature distribution may include: determining a ratio between the determined number and a total number of feature values included in the feature data; and selecting the target feature distribution from among the candidate feature distributions based on the determined ratio.

The selecting of the target feature distribution may include selecting the target feature distribution as a feature distribution corresponding to a ratio interval to which the determined ratio belongs from among the candidate feature distributions, wherein the candidate feature distributions correspond to different ratio intervals.

The determining of the quantization parameter may include determining one or more quantization parameters, for performing the quantization, based on a distribution form of the target feature distribution.

The method may include: determining whether output data of the neural network, determined based on the quantized feature data, satisfies a condition; and in response to the output data not satisfying the condition, adjusting the quantization parameter.

The determining may include determining, as whether the output data satisfies the condition, whether an accuracy determined based on the output data is greater than a threshold value.

The first feature value may correspond to 0.

The quantization parameter may include either one of a quantization interval and a quantization factor.

The layer may correspond to an input layer or a hidden layer of the neural network, and the other layer may correspond to a hidden layer or an output layer subsequent to the layer.

The neural network may be a convolutional neural network (CNN), and the feature data may be a feature map.

A non-transitory computer-readable storage medium may store instructions that, when executed by a processor, configure the processor to perform the method.

In another general aspect, a neural network data processing apparatus includes: a processor configured to: determine a total number of either one of a first feature value and values less than or equal to the first feature value, in feature data output from a layer of a neural network; determine a quantization parameter based on the determined number; quantize the feature data based on the determined quantization parameter; and input the quantized feature data to a another layer of the neural network connected to the layer.

For the determining of the quantization parameter, the processor may be configured to:
select a target feature distribution corresponding to the feature data from among candidate feature distributions based on the determined number; and determine the quantization parameter based on the selected target feature distribution.

For the selecting of the target feature distribution, the processor may be configured to determine a ratio between the determined number and a total number of feature values included in the feature data; and select the target feature distribution from among the candidate feature distributions based on the determined ratio.

For the selecting of the target feature distribution, the processor may be configured to select the target feature distribution as a feature distribution corresponding to a ratio interval to which the determined ratio belongs from among the candidate feature distributions, wherein the candidate feature distributions correspond to different ratio intervals.

The processor may be configured to: determine whether output data of the neural network, determined based on the quantized feature data, satisfies a condition; and in response to the output data not satisfying the condition, adjust the quantization parameter.

The apparatus may be an electronic apparatus comprising a camera configured to obtain image data, and the feature data output from the layer may be output from the layer based on an input of the image data to the neural network.

In another general aspect, an electronic apparatus includes: a camera configured to obtain image data; and a processor configured to: determine a total number of either one of a first feature value and values less than or equal to the first feature value, in feature data output from a layer of a neural network based on an input of the image data to the neural network; determine a quantization parameter based on the determined number; quantize the feature data based on the determined quantization parameter; and input the quantized feature data to a another layer of the neural network connected to the layer.

The processor may be configured to: select a target feature distribution corresponding to the feature data from among candidate feature distributions based on the determined number; and determine the quantization parameter based on the selected target feature distribution.

The processor may be configured to perform object recognition based on output data of the neural network determined based on an output of the inputting of the quantized feature data to the other layer, and the apparatus further may include an output device configured to output a result of the object recognition through any one or any combination of a visual, auditory, and tactile channel.

The apparatus may include a memory storing instructions that, when executed by the processor, configure the processor to perform the determining of the number, the determining of the quantization parameter, the quantizing of the feature data, and the inputting of the quantized feature data.

Other features and aspects will be apparent from the following detailed description, the drawings, and the claims.

### BRIEF DESCRIPTION OF THE DRAWINGS

FIG. 1 illustrates an example of a data processing apparatus and a neural network.

FIG. 2 illustrates an example of quantization in a data processing method using a neural network.

FIG. 3 illustrates an example of determining a quantization parameter.

FIG. 4 is illustrates an example of a data processing method using a neural network.

FIGS. 5 through 7 illustrate examples of quantization.

FIG. 8 illustrates an example of a data processing apparatus using a neural network.

FIG. 9 illustrates an example of an electronic apparatus.

Throughout the drawings and the detailed description, unless otherwise described or provided, the same reference numerals refer to the same elements, features, and structures.

The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for the purpose of describing particular examples only, and is not to be used to limit the disclosure. As used herein, the singular forms “a,” “an,” and “the” are intended to include the plural forms as well, unless the context clearly indicates otherwise. As used herein, the term “and/or” includes any one and any combination of any two or more of the associated listed items. As used herein, the terms “include,” “comprise,” and “have” specify the presence of stated features, numbers, operations, elements, components, and/or combinations thereof, but do not preclude the presence or addition of one or more other features, numbers, operations, elements, components, and/or combinations thereof. The term used in the embodiments such as “unit”, etc., indicates a unit for processing at least one function or operation, and where the unit is hardware or a combination of hardware and software. The use of the term “may” herein with respect to an example or embodiment (for example, as to what an example or embodiment may include or implement) means that at least one example or embodiment exists where such a feature is included or implemented, while all examples are not limited thereto.

In addition, terms such as first, second, A, B, (a), (b), and the like may be used herein to describe components. Each of these terminologies is not used to define an essence, order, or sequence of a corresponding component but used merely to distinguish the corresponding component from other component(s). Although terms of “first” or “second” are used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween. Likewise, expressions, for example, “between” and “immediately between” and “adjacent to” and “immediately adjacent to” may also be construed as described in the foregoing.

Unless otherwise defined, all terms, including technical and scientific terms, used herein have the same meaning as commonly understood by one of ordinary skill in the art to which this disclosure pertains consistent with and after an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

Also, in the description of example embodiments, detailed description of structures or functions that are thereby known after an understanding of the disclosure of the present application will be omitted when it is deemed that such description will cause ambiguous interpretation of the example embodiments.

Hereinafter, examples will be described in detail with reference to the accompanying drawings, and like reference numerals in the drawings refer to like elements throughout.

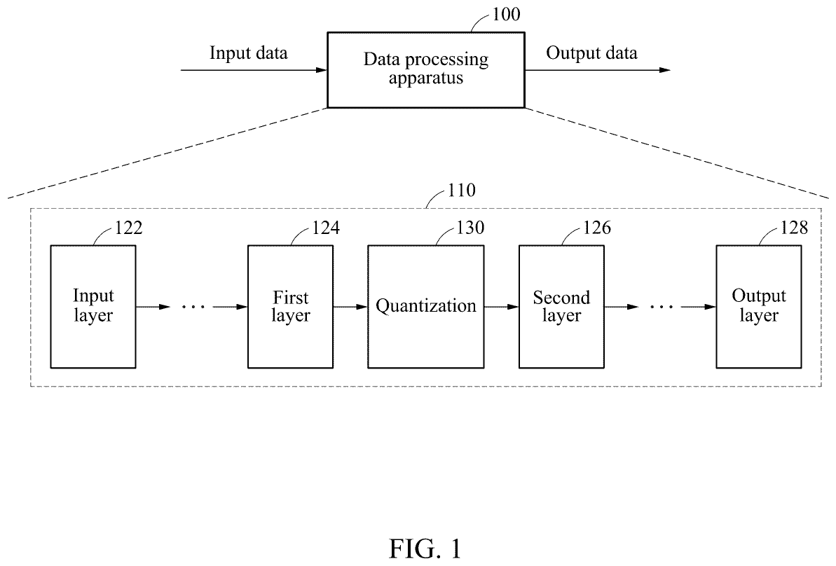

FIG. 1 illustrates an example of a data processing apparatus and a neural network.

Referring to FIG. 1, a data processing apparatus 100 may process input data using a neural network 110 and generate output data as the result of processing the input data. For example, the data processing apparatus 100 may perform object recognition on the input data using the neural network 110 and output object recognition result data which is data obtained as the result of the object recognition. At least a portion of processing operations associated with the neural network 110 may be embodied by hardware including a neural processor, or a combination hardware and software. The data processing apparatus 100 may be or be provided in, for example, a mobile phone, a desktop, a laptop, a tablet personal computer (PC), a wearable device, a smart television (TV), a smart vehicle, a security system, a smart home system, a smart home appliance, and the like.

When processing input data using the neural network 110, the data processing apparatus 100 may lighten data to be processed by the neural network 110 to be a low (or lower) bit width, which may be referred to as lightening. Such lightening may include quantization that quantizes feature data transferred between layers in the neural network 110.

The term “feature data” used herein may also be referred to as a feature map, feature map data, an activation, activation data, an activation map, activation map data.

The neural network 110 may include a plurality of layers. For example, as illustrated, the layers may include an input layer 122, one or more hidden layers, and an output layer 128. The first layer 124 and the second layer 126 may be at least a portion of the plurality of layers included in the neural network 110 (e.g., the first layer 124 and the second layer 126 may be included in the one or more hidden layers). The second layer 126 may be a subsequent layer of the first layer 124, and after data is processed in the first layer 124, the data is then processed in the second layer 126 (e.g., without the data being processed by another hidden layer therebetween).

The neural network 110 may perform object recognition and object verification by mapping an input and an output that are in a nonlinear relationship based on deep learning.

The deep learning may be a machine learning method used to solve a given problem from a big dataset. The deep learning may be a process of optimizing the neural network 110, and a process of finding a model or a weight that represents the architecture of the neural network 110.

The neural network 110 may be a deep neural network (DNN), for example, a convolutional neural network (CNN) or a recurrent neural network (RNN). However, the neural network 110 used by the data processing apparatus 100 is not limited to the foregoing examples. Hereinafter, a CNN will be mainly described for the convenience of description.

The CNN may be suitable to process two-dimensional (2D) data such as an image. In the CNN, a convolution operation between an input map and a weight kernel may be performed to process 2D data. In an environment with limited resources (such as, for example, a mobile terminal), such a convolution operation may require a relatively great amount of resources and processing time. Typical facial recognition performed in a mobile terminal may be performed with limited resources and therefore may not generate recognition performance that is robust in various environments. In contrast, the data processing apparatus 100 of one or more embodiments may convert, to low bits, feature data transferred among layers included in the CNN without degrading the recognition performance, thereby achieving high-speed processing while maintaining robust recognition performance in various environments even when the recognition is performed with limited resources (e.g., when the data processing apparatus 100 is, or is included in, the mobile terminal).

The data processing apparatus 100 of one or more embodiments may lighten data processing by the neural network 110, without degrading greatly the performance of the neural network 110, by quantizing feature data transferred among the layers included in the neural network 110. For example, the data processing apparatus 100 may perform quantization 130 on feature data output from the first layer 124, and transfer quantized feature data obtained through the quantization 130 to the second layer 126. The quantization 130 may be performed on at least a portion of the layers included in the neural network 110. In an example, the quantization 130 may be performed on each feature data transferred among the layers included in the neural network 110. Through the quantization 130, the data processing apparatus 100 of one or more embodiments may perform a low-bit operation, thereby improving computation and/or operation efficiency and storage efficiency of the data processing apparatus 100 and/or devices within which the data processing apparatus 100 is included. The quantization 130 may include normalizing feature data which is real values, and/or mapping the feature data (or the normalized feature data) to discrete values.

The data processing apparatus 100 may adaptively quantize the neural network 110 based on the form of a distribution of feature data. The data processing apparatus 100 may determine a quantization parameter, to be used to quantize the feature data, based on the form of the distribution of the feature data to be processed in the neural network 110. The data processing apparatus 100 may lighten the feature data to be a low bit width by quantizing the feature data based on the determined quantization parameter. To achieve high-speed implementation without a great degradation of the performance in a limited embedded system such as a mobile device, the data processing apparatus 100 of one or more embodiments may predict or determine the distribution of the feature data of the neural network 110 in advance of quantizing the feature data and estimate the quantization parameter that dynamically quantizes the feature data.

According to some examples, a process of quantizing, to be a lower bit number, input data that is input to the input layer 122 or a first convolution layer of a CNN may be performed. For example, when quantizing input data which is 8 bits to be a bit number lower than 8 bits is performed, a process such as min-max normalization may be performed on the input data.

The data processing apparatus 100 of one or more embodiments may increase a processing speed and a resource utilization in a limited embedded environment such as a mobile phone, a smart sensor, and the like, and effectively implement recognition and verification technologies, without additionally changing a hardware structure and using an accelerator. In addition, the data processing apparatus 100 of one or more embodiments may increase the processing speed of the neural network 110 while reducing the degradation of the performance of the neural network 110 due to a quantization error that may occur in the quantization.

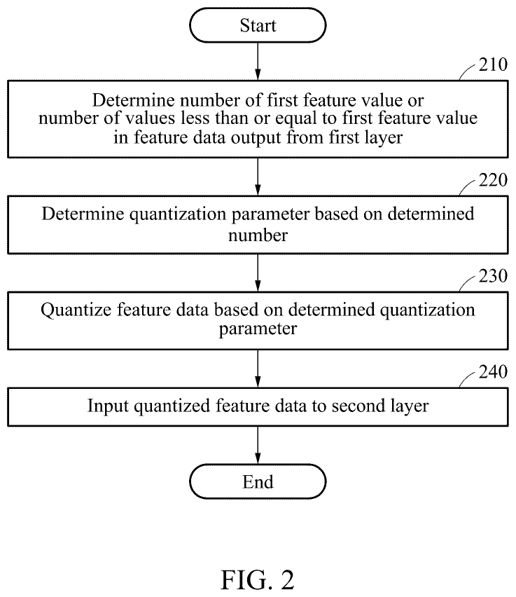

FIG. 2 is illustrates an example of quantization in a data processing method using a neural network. The quantization may be adaptively performed on feature data.

Referring to FIG. 2, in operation 210, a data processing apparatus (e.g., the data processing apparatus 100) may determine the number (e.g., the total number) of a first feature value or the number of values less than or equal to the first feature value, in feature data output from a first layer of a neural network. In an example, the neural network may be a CNN, and the feature data may be a feature map. The first layer may be an input layer or a hidden layer of the neural network. The first feature value may be a feature value corresponding to 0, for example. However, the first feature value may change based on the feature data, and there is no limit to a value that is the first feature value. In an example, the data processing apparatus may count the number of a feature value corresponding to 0 or the number of feature values less than or equal to 0, in feature data output from a hidden layer of a CNN.

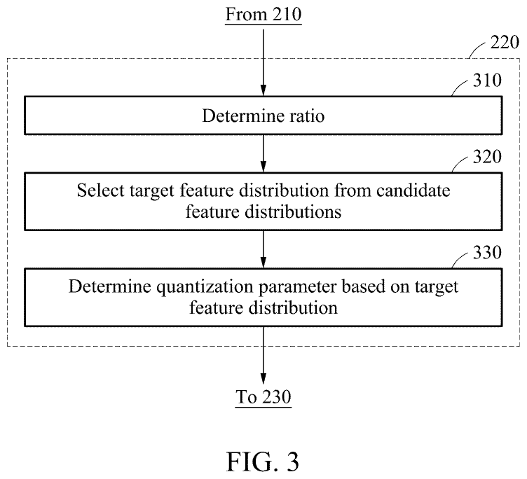

In operation 220, the data processing apparatus may determine a quantization parameter to be used for quantization based on the number of the first feature value or the number of the values less than or equal to the first feature value, which is determined in operation 210. The quantization parameter may include at least one of a quantization interval or a quantization factor, for example. The data processing apparatus may predict or determine a distribution of the feature data based on the number of the first feature value included in the feature data or the number of the values less than or equal to the first feature value, and determine the quantization parameter for the quantization of the feature data based on the predicted distribution. The data processing apparatus may select or determine a target feature distribution corresponding to the feature data from among candidate feature distributions based on the number of the first feature value or the number of the values less than or equal to the first feature value, and determine the quantization parameter based on the selected target feature distribution. A non-limiting example of determining the quantization parameter will be further described in detail hereinafter with reference to FIG. 3.

FIG. 3 illustrates an example of determining a quantization parameter. Referring to FIG. 3, in operation 310, the data processing apparatus may determine a ratio between the number of the first feature value (or the number of the values less than or equal to the first feature value) and a total number of feature values included in the feature data. The data processing apparatus may determine the ratio that indicates the proportion of first feature values (or values less than or equal to the first feature value) included in the feature data. By this ratio, a characteristic of a distribution of the feature data may be estimated.

In operation 320, the data processing apparatus may select the target feature distribution corresponding to the feature data from among the candidate feature distributions based on the ratio determined in operation 310. In an example, the candidate feature distributions may have predefined different distribution forms. The data processing apparatus may select the target feature distribution corresponding to a ratio interval to which the ratio determined in operation 310 belongs from among the candidate feature distributions corresponding to different ratio intervals. By selecting the target feature distribution that is most approximate to the distribution of the feature data from among the candidate feature distributions, the quantization may be performed in the most suitable way (e.g., to best achieve high-speed processing while maintaining robust recognition performance) for the characteristic of the distribution of the feature data.

In operation 330, the data processing apparatus may determine the quantization parameter based on the target feature distribution selected in operation 320. The data processing apparatus may determine one or more quantization parameters associated with performing the quantization based on the form of the target feature distribution. Different quantization parameters may be extracted respectively from the candidate feature distributions. The data processing apparatus may extract the quantization parameter (for example, a quantization interval and/or a quantization factor (or a quantization scale)) based on the target feature distribution corresponding to the ratio determined in operation 310. As described above, the quantization parameter may be dynamically determined based on the ratio.

Referring back to FIG. 2, in operation 230, the data processing apparatus may quantize the feature data based on the determined quantization parameter. The data processing apparatus may convert the feature data to feature data of a low bit width by quantizing the feature data based on the quantization parameter (for example, the quantization interval and/or the quantization factor) extracted from the target feature distribution.

In operation 240, the data processing apparatus may input the quantized feature data to a second layer of the neural network connected to the first layer of the neural network. The second layer may be a hidden layer or an output layer connected and/or subsequent to the first layer. When a third layer is connected to the second layer, the data processing apparatus may quantize feature data output from the second layer and input the quantized feature data to the third layer, in a similar way as described above.

As described above, the data processing apparatus of one or more embodiments may perform quantization through an optimal quantization interval that is determined as suitable for a characteristic of a distribution of feature data. Thus, a feature of input data may be better obtained in a data processing process using a neural network, and thus the neural network may operate at a high speed without a great degradation of performance. In addition, the data processing apparatus may perform quantization robustly in an environment where feature values of the feature data are distributed, thereby preventing the great degradation of the performance of the neural network.

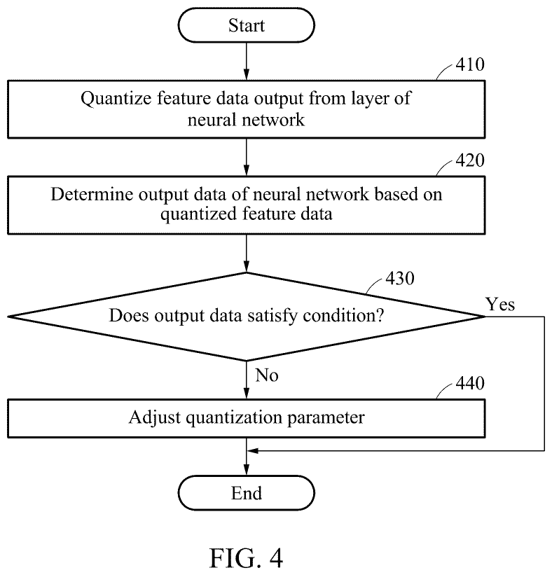

FIG. 4 illustrates an example of a data processing method using a neural network.

Referring to FIG. 4, in operation 410, a data processing apparatus (e.g., the data processing apparatus 100) may quantize feature data output from a layer of a neural network.

The data processing apparatus may quantize the feature data as described above with reference to FIGS. 2 and 3, and thus a more detailed and repeated description will be omitted here.

In operation 420, the data processing apparatus may determine output data of the neural network based on the quantized feature data. The data processing apparatus may quantize one or more sets of feature data transferred among layers included in the neural network, and the output data may be output from an output layer of the neural network based on the quantized feature data. For example, the data processing apparatus may iteratively input quantized feature data to a subsequent layer for each of subsequent layers of the neural network, based on the operations described above with reference to FIGS. 2 and 3, wherein data output from an output layer based on quantized feature data input to the output layer is output data of the neural network.

In operation 430, the data processing apparatus may determine whether the output data of the neural network determined based on the quantized feature data satisfies a condition. In an example, the data processing apparatus may calculate an accuracy based on the output data using a predefined calculation method, and determine whether the calculated accuracy is greater than a threshold value as whether the output data satisfies the condition.

In operation 440, when the output data does not satisfy the condition, the data processing apparatus may adjust a quantization parameter of a target feature distribution that is used for quantization of the feature data. For example, the data processing apparatus may update the quantization parameter set in the target feature distribution through a learning process. The data processing apparatus may calculate a difference between the output data of the neural network and desired data (or verification data), determine the quantization parameter of the target feature distribution that minimizes the difference, and update the determined quantization parameter. Through such an updating process, the quantization parameter may change more desirably such that the accuracy based on the output data is increased.

According to some examples, a prediction process of matching feature data to a target feature distribution among candidate feature distributions may be trained or learned through the learning process. In an example, the updated quantization parameter is used as a new quantization parameter in a subsequent performance of the operations of FIG. 2 based on new feature data output from the first layer based on new input data. Accordingly, the updated quantization parameter may be stored in a memory of the data processing apparatus 100 for subsequent use.

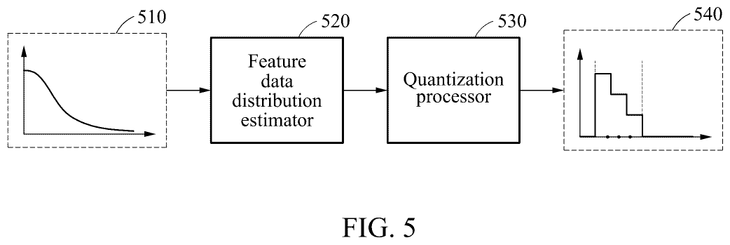

FIGS. 5 through 7 illustrate examples of quantization.

Referring to FIG. 5, a data processing apparatus (e.g., the data processing apparatus 100) may include a feature data distribution estimator 520 and a quantization processor 530. In an example, the feature data distribution estimator 520 may be, or be included in, another processor of the data processing apparatus. In an example, both the feature data distribution estimator 520 and the quantization processor 530 may be, or be included in, a same processor of the data processing apparatus. In an example of FIG. 5, feature data 510 may be output from a first layer of a neural network. The feature data distribution estimator 520 may estimate a distribution of the feature data 510. Here, the term “distribution” may indicate a distribution of feature values in the feature data 510. A horizontal axis of the feature data 510 may indicate a magnitude of a feature value, and a vertical axis of the feature data 510 may indicate a frequency of the feature value.

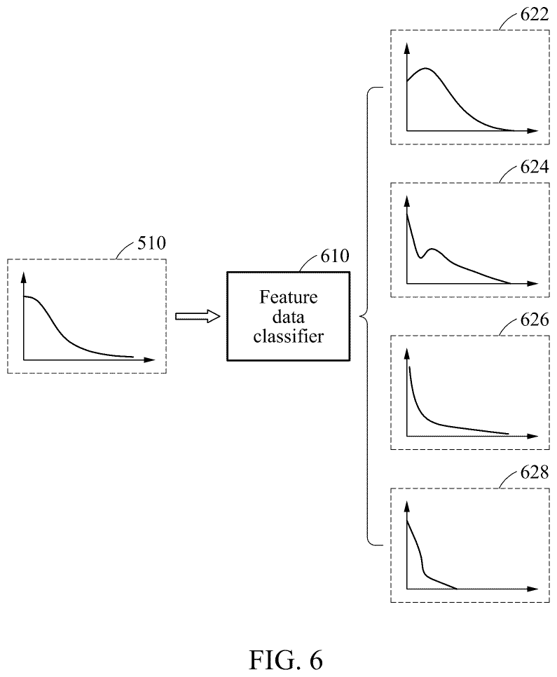

The feature data distribution estimator 520 may count the number of a first feature value or the number of values less than or equal to the first feature value in the feature data 510, and estimate the distribution of the feature data 510 based on the counted number. The feature data distribution estimator 520 may determine a target feature distribution corresponding to the feature data 510 based on the counted number. A non-limiting example of such will be further described in detail hereinafter with reference to FIG. 6.

Referring to FIG. 6, the feature data distribution estimator 520 may include a feature data classifier 610. The feature data classifier 610 may count the number of a first feature value (e.g., a feature value of 0) in the feature data 510, which may be referred to as zero counting, or count the number of values less than or equal to the first feature value in the feature data 510. The feature data classifier 610 may then determine a ratio between a total number of feature values included in the feature data 510 and the counted number of the first feature value (or the counted number of the values less than or equal to the first feature value). The feature data classifier 610 may select a target feature distribution corresponding to the feature data 510 from a plurality of candidate feature distributions 622, 624, 626, and 628 based on the determined ratio. In an example, the candidate feature distributions 622, 624, 626, and 628 are predetermined.

In an example, a first candidate feature distribution 622 may correspond to a ratio which is greater than or equal to 0 and less than 30%, a second candidate feature distribution 624 may correspond to a ratio which is greater than or equal to 30% and less than 50%, a third candidate feature distribution 626 may correspond to a ratio which is greater than or equal to 50% and less than 70%, and a fourth candidate feature distribution 628 may correspond to a ratio which is greater than or equal to 70% and less than or equal to 100%. In an example, such ratio intervals respectively corresponding to each of the candidate feature distributions 622, 624, 626, and 628 may be predetermined. A horizontal axis and a vertical axis of each of the candidate feature distributions 622, 624, 626, and 628 may indicate a magnitude of a feature value and a frequency of the feature value, respectively. For example, when the ratio between the total number of the feature values included in the feature data 510 and the number of the first feature value (or the number of the values less than or equal to the first feature value) is determined to be 20%, the feature data classifier 610 may determine that the ratio corresponds to the first candidate feature distribution 622, and, in response, the feature data classifier 610 may select the first candidate feature distribution 622 as the target feature distribution. Here, the ratio between the total number and the number of the first feature value may be a ratio of the number of the first feature value to the total number. Through such a process, the target feature distribution that is most suitable for the characteristic of the distribution of the feature data 510 may be selected from the candidate feature distributions 622, 624, 626, and 628. Hereinafter, in an example, the first candidate feature distribution 622 may be selected as the target feature distribution.

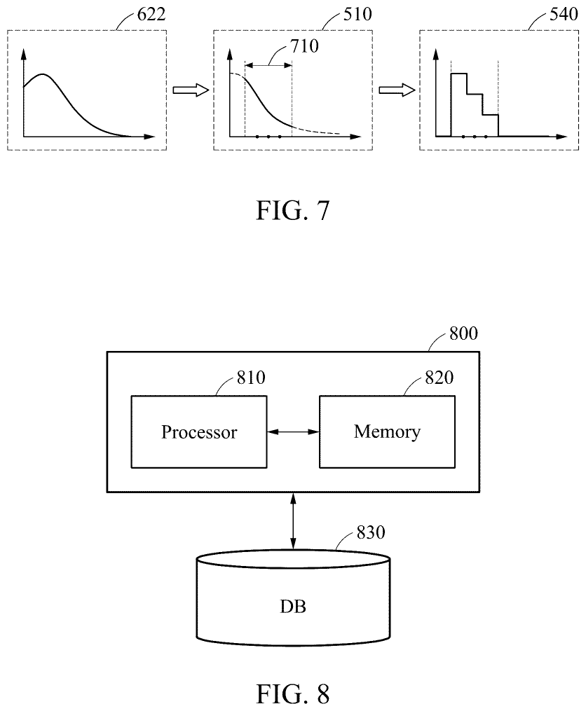

Referring back to FIG. 5, the quantization processor 530 may determine a quantization parameter, for example, a quantization interval, based on the target feature distribution selected by the feature data distribution estimator 520, and generate quantized feature data 540 by quantizing the feature data 510 based on the determined quantization parameter. A non-limiting example of such will be described in further detail hereinafter with reference to FIG. 7.

Referring to FIG. 7, the quantization processor 530 may estimate a quantization parameter (for example, a quantization interval 710 and/or a quantization scale) based on the selected target feature distribution 622, and quantize the feature data 510 based on the estimated quantization parameter. The quantization may include mapping feature values of the feature data 510 in the quantization interval 710 to discrete feature values (for example, integers) to generate the quantized feature data 540. In a non-limiting example, the quantization parameter (for example, the quantization interval 710 and/or the quantization scale) is predetermined for the selected target feature distribution 622, or is extracted from the selected target feature distribution 622.

Through such a quantization, the feature data 510 may be converted into the quantized feature data 540 of a low bit width. For example, when the feature data 510 is 32 bits, the quantized feature data 540 may have a bit number less than 32 bits, for example, 4 bits or 8 bits. The quantized feature data 540 may be input to a second layer of the neural network that is connected to the first layer. As described above, the feature data 510 may be dynamically quantized based on a distribution of a certain feature value included in the feature data 510.

Compared to a quantization method based on a variance of a feature value or a minimum and maximum value of a feature value, the dynamic quantization method may determine a quantization parameter that is more suitable for a distribution of a feature value of the feature data 510, and thus relatively reduce the degradation of performance of the neural network that may occur due to a quantization error.

FIG. 8 is illustrates an example of a data processing apparatus using a neural network.

Referring to FIG. 8, a data processing apparatus 800 (e.g., the data processing apparatus 100) may perform one or more or all operations or methods described herein with respect to FIGS. 1 through 7 in relation to a data processing method.

The data processing apparatus 800 may include at least one processor 810 and at least one memory 820. In the examples, a processor may mean one or more processors, and a memory may mean one or more memories. The memory 820 may be connected to the processor 810, and store instructions executable by the processor 810, and data to be processed by the processor 810 or data processed by the processor 810. The memory 820 may include a non-transitory computer-readable medium, for example, a high-speed random-access memory (RAM), and/or a nonvolatile computer-readable storage medium, for example, at least one disk storage device, a flash memory device, and other nonvolatile solid-state memory devices.

The processor 810 may process data using a neural network. The neural network may be stored in a database (DB) 830. The processor 810 may quantize feature data transferred among layers of the neural network, thereby increasing a data processing speed and lightening the neural network.

In an example, the processor 810 may perform the following quantization on feature data. The processor 810 may determine the number of a first feature value or the number of values less than or equal to the first feature value in feature data output from a first layer of the neural network, and determine a quantization parameter based on the determined number. The processor 810 may select a target feature distribution corresponding to the feature data from among candidate feature distributions based on the determined number, and determine the quantization parameter to be used for quantization based on the target feature distribution. The processor 810 may determine a ratio between a total number of feature values included in the feature data and the number of the first feature value (or the number of the values less than or equal to the first feature value), and then select the target feature distribution from among the candidate feature distributions based on the determined ratio. The processor 810 may select the target feature distribution corresponding to a ratio interval to which the determined ratio belongs from among the candidate feature distributions respectively corresponding to different ratio intervals. The processor 810 may quantize the feature data based on the quantization parameter determined based on the selected target feature distribution, and input the quantized feature data to a second layer of the neural network connected to the first layer.

In another example, the processor 810 may determine whether output data output from the neural network through the quantization of the feature data satisfies a condition. For example, when accuracy determined based on the output data of the neural network is greater than a threshold value, the processor 810 may determine that the output data satisfies the condition. In contrast, when the output data does not satisfy the condition, the processor 810 may adjust the quantization parameter of the target feature distribution used for the quantization. For example, the processor 810 may update the quantization parameter set in the target feature distribution through a learning process. The processor 810 may calculate a difference between the output data of the neural network and desired data, determine the quantization parameter of the target feature distribution that minimizes the difference, and update the determined quantization parameter.

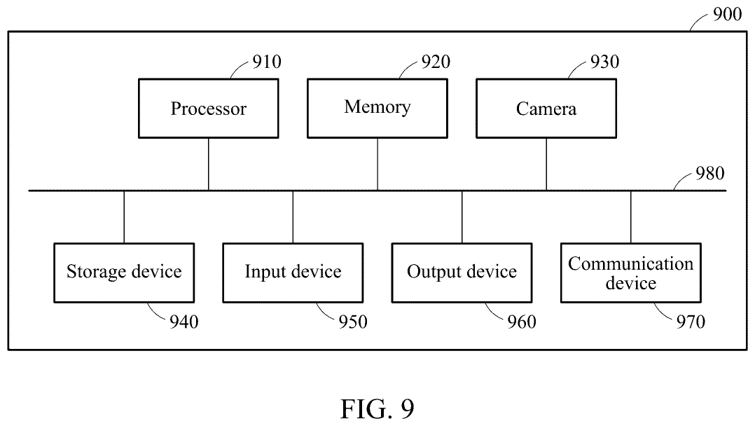

FIG. 9 illustrates an example of an electronic apparatus.

A data processing apparatus (e.g., the data processing apparatus 100 and/or the data processing apparatus 800) described herein may be included in an electronic apparatus 900 to operate therein, and the electronic apparatus 900 may perform one or more operations that are performed by the data processing apparatus. The electronic apparatus 900 may be, for example, a mobile phone, a wearable device, a tablet PC, a netbook, a laptop, a desktop, a personal digital assistant (PDA), a set-top box, a smart home appliance, a security device, and the like. In an example, the electronic apparatus 900 corresponds to either of the data processing apparatus 100 and the data processing apparatus 800.

Referring to FIG. 9, the electronic apparatus 900 may include a processor 910, a memory 920, a camera 930, a storage device 940, an input device 950, an output device 960, and a communication device 970. The processor 910, the memory 920, the camera 930, the storage device 940, the input device 950, the output device 960, and the communication device 970 may communicate with one another through a communication bus 980. In the examples, a processor may mean one or more processors, and a memory may mean one or more memories.

The camera 930 may obtain a still image, a moving or video image, or both images as image data. The obtained image data may be, for example, a color image, a black-and-white image, or an infrared image.

The processor 910 may execute a function and an instruction in the electronic apparatus 900. For example, the processor 910 may process instructions stored in the memory 920 or the storage device 940. The processor 910 may perform one or more of the operations or methods described above with reference to FIGS. 1 through 8. In an example, the processor 910 may process image data using a neural network. When processing the image data, the processor 910 may perform quantization in relation to operations of the neural network. Through the quantization, feature data transferred among layers included in the neural network may be quantized, and thus a processing process of the neural network may be lightened. For a more detailed description of the quantization, reference may be made to what has been described above, and a detailed and repeated description will be omitted here.

The storage device 940 may include a computer-readable storage medium or a computer-readable storage device. The storage device 940 may include a DB that stores the neural network. The storage device 940 may include, for example, a magnetic hard disk, an optical disc, a flash memory, a floppy disk, an electrically erasable programmable read-only memory (EEPROM), and other types of nonvolatile memory that are well-known in the related technical field.

The input device 950 may receive an input from a user through a traditional input method including, as non-limiting examples, a keyboard and a mouse, and a new input method, for example, a touch input, a voice input, and an image input. The input device 950 may include, for example, a keyboard, a mouse, a touchscreen, a microphone, and other devices that may detect the input from the user and transmit the detected input to the electronic apparatus 900.

The output device 960 may provide an output (e.g., an object recognition result) of the electronic apparatus 900 to a user through a visual, auditory, or tactile channel. The output device 960 may include, for example, a display, a liquid crystal display, a light-emitting diode (LED) display, a touchscreen, a speaker, a vibration generator, and other devices that may provide the output to the user.

The communication device 970 may communicate with an external device through a wired or wireless network.

The data processing apparatuses, feature data distribution estimators, quantization processors, feature data classifiers, processors, memories, DBs, electronic apparatuses, cameras, storage devices, input devices, output devices, communication devices, communication buses, data processing apparatus 100, feature data distribution estimator 520, quantization processor 530, feature data classifier 610, data processing apparatus 800, processor 810, memory 820, DB 830, electronic apparatus 900, processor 910, memory 920, camera 930, storage device 940, input device 950, output device 960, communication device 970, communication bus 980, and other apparatuses, devices, units, modules, and components described herein with respect to FIGS. 1 through 9 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1 through 9 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions used herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media.

Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

1. A processor-implemented neural network data processing method, comprising:
receiving a target input by a processor executing a neural network comprising layers of nodes, and based thereon, in performing inference on the target input:
generating feature data by the nodes in a first layer of a neural network, wherein the feature data comprises feature values respectively outputted from the nodes based on inputs thereto, wherein the inputs correspond to, or are comprised in, the target input inputted to the neural network;
determining a count of the feature values, wherein the count is determined by counting how many of the feature values satisfy a condition with respect to a first value;
determining a ratio of the determined count to a total number of the feature values for
selecting from among candidate feature distributions a target feature distribution corresponding to a ratio interval to which the determined ratio belongs, wherein the candidate feature distributions correspond to different ratio intervals respectively, and wherein whichever of the candidate feature distributions is most approximate to the distribution of the feature data is selected as the target feature distribution:
determining quantization parameter associated with the ratio based on the selected target feature distribution, wherein the quantization parameter comprises a quantization interval and a quantization scale corresponding to the ratio;
quantizing the feature values based on the determined quantization parameter;
inputting the quantized feature values to a second layer of the neural network that is connected to the first layer to generate an output from the second layer; and
performing, by the processor executing the neural network, object recognition on the target input using the output from the second layer; and
outputting, by the processor executing the neural network, object recognition result data obtained as a result of the object recognition.

2. The method of claim 1, further comprising:
determining whether output data of the neural network, determined based on the quantized feature data, satisfies a second condition; and
in response to the output data not satisfying the second condition, adjusting the quantization parameter.

3. The method of claim 2, wherein the determining whether the output data of the neural network satisfies the second condition comprises:
determining whether an accuracy determined based on the output data is greater than a threshold value.

4. The method of claim 1, wherein the first value is zero.

5. The data processing method of claim 1, wherein
the first layer corresponds to an input layer or a hidden layer of the neural network, and
the second layer corresponds to a hidden layer or an output layer subsequent to the layer.

6. The method of claim 1, wherein
the neural network is a convolutional neural network (CNN),
the target input comprises an image and the feature data is a feature map derived from the image, and
the CNN outputs an inference about the image.

7. A non-transitory computer-readable storage medium storing instructions that, when executed by a processor, configure the processor to perform the method of claim 1.

8. A neural network data processing apparatus comprising a processor configured to receive a target input by the processor executing a neural network comprising layers of nodes, and based thereon, in performing inference on the target input:
generate feature data by the nodes in a first layer of the neural network, wherein the feature data comprises feature values respectively outputted from the nodes based on inputs thereto, wherein the inputs correspond to, or are comprised in, the target input;
determine a count of the feature values, wherein the count is determined by counting how many of the feature values satisfy a condition with respect to a first value;
determine a ratio of the determined count to a total number of the feature values;
select from among candidate feature distributions a target feature distribution corresponding to a ratio interval to which the determined ratio belongs, wherein the candidate feature distributions correspond to different ratio intervals respectively, and wherein whichever of the candidate feature distributions is most approximate to the distribution of the feature data is selected as the target feature distribution, and
determine a quantization parameter associated with the ratio be d on the Hected target feature distribution, wherein the quantization parameter comprises a quantization interval and a quantization scale corresponding to the ratio;
quantize the feature values based on the determined quantization parameter;
input the quantized feature values to a second layer of the neural network that is connected with the first layer to generate an output from the second laver; and
perform object recognition, by the neural network, on the target input using an the output from the second layer, and output object recognition result data which is data obtained as a result of the object recognition.

9. The apparatus of claim 8, wherein the processor is configured to:
determine whether output data of the neural network, determined based on the quantized feature data, satisfies a second condition; and
in response to the output data not satisfying the second condition, adjust the quantization parameter.

10. The data processing apparatus of claim 8, wherein the apparatus comprises a camera configured to obtain image data, and
the target input comprises the image data.

11. An electronic apparatus comprising:
a camera configured to obtain image data, wherein a target input comprises or is derived from the image data; and
a processor configured to receive the target input by the processor executing a neural network comprising layers of nodes, and based thereon, in performing inference on the target input:
generate feature data by the nodes in a first layer of the neural network, wherein the feature data comprises feature values respectively outputted from the nodes based on inputs thereto, wherein the inputs correspond to, or are comprised in, the target input;
determine a count of the feature values, wherein the count is determined by counting how many of the feature values satisfy a condition with respect to a first value or by determine a ratio of the determined count to a total number of the feature values;
select from among candidate feature distributions a target feature distribution corresponding to a ratio interval to which the determined ratio belongs, wherein the candidate feature distributions correspond to different ratio intervals respectively, and wherein whichever of the candidate feature distributions is most approximate to the distribution of the feature data is selected as the target feature distribution;
determine a quantization parameter associated with the ratio based on the selected target feature distribution, wherein the quantization parameter comprises a quantization interval and a quantization scale corresponding to the ratio;
quantize the feature values based on the determined quantization parameter;
input the quantized feature values to a second layer of the neural network that is connected with the first layer to generate an output from the second laver;
perform object recognition, by the neural network, on the target input using the output from the second layer; and
output object recognition result data which is data obtained as a result of the object recognition.

12. The method of claim 1, wherein the condition comprises a feature value being equal to the first value or a feature value being less than or equal to the first value, such that determining the count comprises counting how many of the feature values equal the first or counting how many of the feature values are less than or equal to the first value.

13. The neural network data processing apparatus of claim 8, wherein the condition comprises a feature value being equal to the first value or a feature value being less than or equal to the first value, such that determining the count comprises counting how many of the feature values equal the first or counting how many of the feature values are less than or equal to the first value.

14. The neural network data processing apparatus of claim 8, wherein the quantization parameter is pre-associatedf with the target feature distribution.

15. The neural network data processing apparatus of claim 8, whereint he quantization parameter is extracted from the target feature distribution.

16. The electronic apparatus of claim 11, wherein the condition comprises a feature value being equal to the first value or a feature value being less than or equal to the first value, such that determining the count comprises counting how many of the feature values equal the first or counting how many of the feature values are less than or equal to the first value.
